(19) United States
(12) Patent Application Publication
(10) Pub. No.: US 2025/0234808 A1
(43) Pub. Date: Jul. 24, 2025

(54) CORN SHUCKER

(71) Applicants: James A. Druliner, Omaha, NE (US); Donald E. Novak, Omaha, NE (US)

(72) Inventors: James A. Druliner, Omaha, NE (US); Donald E. Novak, Omaha, NE (US)

(21) Appl. No.: 18/418,637

(22) Filed: Jan. 22, 2024

(51) Int. Cl. A01D 45/02; A01D 34/835

(52) U.S. Cl. CPC A01D 45/021; A01D 34/8355

(57) ABSTRACT

A corn kernel harvesting device and method thereof is provided. As the corn kernel harvesting device, or corn shucker, moves from a first configuration to a second configuration, the device separates corn kernels from its respective inner core, such as a corn cob. The corn kernel harvesting device comprises an ejection assembly, harvesting assembly, discharge assembly, and is configured to enable a user to remove corn kernels efficiently and consistently from a corn cob.

### FIELD OF THE INVENTION

The present invention relates generally to a corn kernel harvesting device. More specifically, the present invention is concerned with a device and method for efficiently separating corn kernels from its cob.

### BACKGROUND

From sweet corn to flour corn, and from field corn to flint corn, there exists thousands of varieties of corn and, this high yielding global commodity, is one of the world's most heavily subsidized products. Corn belongs to the plant species, Zea mays, and is a product of ingenuity as farmers used artificial selection to eventually reach one of the world's most productive and dominate crops. This versatile crop, also known as maize, is a type of grass that comprises a corn stalk, which consists of leaves branching out from a central stem, wherein the central stem is a slender structure that may bear multiple ears of corn. Extending from the topmost portion of the stalk is the male flower, or tassel, while the female flowers extend from the central stalk, eventually forming ears of corn.

A corn ear is comprised of the corn husk, silk layers, and corn kernels. Wherein the corn husk is the outer layer of leaves surrounding the kernels and cob. The silk layers form below the husk and are long, thread-like, fibers that grow as part of the corn ear and eventually for the tuff or tassel extending from the end of the corn ear. Within the husk and under the silk are the plant's fruit, the corn kernels. One single ear of corn may include up to several hundred individual kernels in multiple rows. These kernels grow outwardly from a central core, called the cob.

While there are uses for the remaining parts of the plant and ear of corn, the corn's kernels are the most widely used and sought after. Given corn's prevalence and usability, these kernels are utilized in a variety refined goods, industrial items, and food products, wherein this versatile grain is widely used for food items, such as popcorn, corn flour, corn syrup, oil, tortillas, cereal, among numerous other types of food products.

As such, it is often desirable to separate the corn's kernels from its inner core, the corn cob. This process is often referred to as shucking or kerneling. While there currently exists methods and devices for shucking corn, each method or device also includes disadvantages not solved by the current art. Existing systems and methods are often dangerous and yield inconsistent kernel harvesting. For example, one method of shucking corn requires a user to peel away the outer leaves, inner leaves, and silk layers, then using a sharp object, such as a knife, to cut away the corn's kernels from its cob. However, using a knife this this manner may result in injuries to the user's hands or body if they encounter the knife's cutting edge. Moreover, removing the kernels with a knife, often results in the kernel being inconsistently cut away from the cob, which results in waste as part of the kernels remain affixed to the cob. Accordingly, there exists a need to have a system for and method of safely and consistently removing corn kernels from a corn cob.

Another disadvantage of existing systems and methods is that they require a user to spend a significant amount of time due to the painstaking process of removing the kernels from the cob with devices and methods available in the current art. Additionally, and in turn, as the existing systems and methods require a user to spend countless hours shucking corn, existing systems and methods often results in wastes due to the abundance of corn and the lack of shucking efficiency. Moreover, some existing systems and methods require users to spend hours removing the corn's kernels ether by knife or spoon, merely resulting in inconsistent and wasteful corn harvesting. Accordingly, it would be beneficial to have a system for and method of efficiently removing corn kernels from a corn cob that results in minimal corn kernel waste. Yet another disadvantage of existing systems and methods is that existing corn shucking devices are not easily transported from one location to another, due to size, weight, or complexity of parts. As such, there exist a need to have a system for and method of efficiently removing corn kernels from a corn cob that is easily portable.

### SUMMARY

The present invention comprises a corn stripping device and method for separating corn kernels from an ear of corn, such as a device and method for shucking corn. In various embodiments, the corn shucking device includes an ejection assembly, a harvesting assembly, and a discharge assembly. In some embodiments of the instant invention, each of the forgoing respective assemblies is a portion of, or includes, a frame.

In some embodiments, the ejection assembly is movable from a first configuration to a second configuration. In a preferred embodiment, as the ejection assembly moves from a first position to a second position, the ejection assembly is configured to contact a surface of an elongated object, such as an ear of corn, and urge the elongated object from a first position to a second position. The ejection assembly further facilitates moving the elongated object towards a cutting edge, wherein the cutting edge is configured to separate corn kernels from its cob.

In various embodiments, the corn shucking device includes a harvesting assembly. The harvesting assembly, being configured to support an elongated object on a rest, such that the ejection assembly contacts the elongated object, when the ejection assembly is moved from its first configuration to its second configuration. In various embodiments, the harvesting assembly is designed in such a way as to capture, or retain, corn kernels, as the kernels are separated from a corn cob. In various embodiments, at least part of a cutter is positioned within the harvesting assembly, such that as an elongated object is urged through the harvesting assembly at least a portion of the elongated object is separated from its inner core and the at least a portion of the elongated object remains in the harvesting assembly until the at least a portion of the elongated object removed by a user.

In various embodiments, the corn shucking device includes a discharge assembly. In some embodiments, the discharge assembly is designed in such a way as to guide at least a portion of an elongated object, such as a corn cob, in a direction away from the corn shucker. In some embodiments, as the elongated object, such as an ear of corn, moves through the harvesting assembly, the corn's kernels remain in the harvesting assembly and the corn's cob continues to move through a cutter inner passage and towards the discharge assembly.

In various embodiments, the corn shucking device includes a control system. The control system being configured to move the ejection assembly from its first configuration to a second configuration. In some embodiments, the control system is configured to interface with the instant invention, such that the controls facilitate the instant invention in separating a corn's kernels from a corn cob. In some embodiments, a user moves a control device/system, such as a push button, from a first position to a second position, thereby causing the present device to move from a first configuration to a second configuration before automatically returning to the first configuration.

In various embodiments, the corn shucking device removes a substantial portion of a corn's kernels from its inner core, such as the corn cob. In various embodiments, a user places an elongated object, such as an ear of corn, in the harvesting assembly, then the user utilizes the control system to move the ejection assembly from its first configuration to its second configuration. As the ejection assembly moves from its first configuration to its second configuration, it urges the ear of corn towards a cutter, wherein a cutting surface of the cutter contacts an area of the elongated object where the corn's kernel extend from its inner core. As the ear of corn is moved through the harvesting assembly towards the discharge assembly, a cutting edge of a cutter separates the corn's kernels from its cob, and a substantial portion of the corn's kernels remain in the harvesting assembly and the corn's cob continues to move through a cutter inner passage and towards and the discharge assembly.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is a perspective view of a corn kernel harvesting device embodying the present invention.

FIG. 2 is a perspective view of a corn kernel harvesting device of FIG. 1 embodying the present invention shown at a different angle that FIG. 1.

FIG. 3 is a perspective view of a corn kernel harvesting device of FIG. 1 embodying the present invention.

FIG. 4 is a perspective view of a corn kernel harvesting device of FIG. 1 embodying the present invention shown at a different angle that FIG. 1.

FIG. 5 is an isometric view of an embodiment of a frame middle section side portion.

FIG. 6 is an isometric view of an embodiment of the frame middle section side portion of FIG. 5 shown from a different angle.

FIG. 7 is an isometric view of an embodiment of the frame middle section side portion of FIG. 5 shown from a different angle.

FIG. 8 is an isometric view of an embodiment of a frame middle section end portion.

FIG. 9 is an isometric view of an embodiment of a frame middle section end portion of FIG. 8 shown from a different angle.

FIG. 10 is an isometric view of an embodiment of a frame middle section end portion of FIG. 8 shown from a different angle.

FIG. 11 is an isometric view of an embodiment of an elongated member.

FIG. 12 is an isometric view of an embodiment of the elongated member of FIG. 11 shown from a different angle.

FIG. 13 is an isometric view of an embodiment of the elongated member of FIG. 11 shown from a different angle.

FIG. 14 is an isometric view of an embodiment of an outfall plate.

FIG. 15 is an isometric view of an embodiment of an outfall plate of FIG. 14 shown from a different angle.

FIG. 16 is an isometric view of an embodiment of a L-bracket tab member.

FIG. 17 is an isometric view of an embodiment of the L-bracket tab member of FIG. 16 shown from a different angle.

FIG. 18 is an isometric view of an embodiment of the L-bracket tab member of FIG. 16 shown from a different angle.

FIG. 19 is a perspective view of an embodiment of the L-bracket tab member of FIG. 16.

FIG. 20 is an isometric view of an embodiment of a frame brace.

FIG. 21 is an isometric view of an embodiment of the frame brace of FIG. 20 shown from a different angle.

FIG. 22 is an isometric view of an embodiment of a frame surface mount tab member.

FIG. 23 is an isometric view of an embodiment of the frame surface mount tab member of FIG. 22 shown from a different angle.

FIG. 24 is an isometric view of an embodiment of frame tab member.

FIG. 25 is an isometric view of an embodiment of the frame tab member of FIG. 24 shown from a different angle.

FIG. 26 is a perspective view of an embodiment of the frame tab member of FIG. 24.

FIG. 27 is an isometric view of an embodiment of a bridge member.

FIG. 28 is an isometric view of an embodiment of the bridge member of FIG. 27 shown from a different angle.

FIG. 29 is an isometric view of an embodiment of a tab member.

FIG. 30 is an isometric view of an embodiment of the tab member of FIG. 29 shown from a different angle.

FIG. 31 is a perspective view of an embodiment of the tab member of FIG. 29.

FIG. 32 is an isometric view of an embodiment of a tab member.

FIG. 33 is an isometric view of an embodiment of the tab member of FIG. 32 shown from a different angle.

FIG. 34 is a perspective view of an embodiment of the tab member of FIG. 32.

FIG. 35 is an isometric view of an embodiment of a cutter.

FIG. 36 is a sectional view on an embodiment of the cutter of FIG. 35.

FIG. 37 is an isometric view of an embodiment of the cutter of FIG. 35 shown from a different angle.

FIG. 38 is a perspective view of an embodiment of the cutter of FIG. 35.

FIG. 39 is an isometric view of an embodiment of a tube.

FIG. 40 is an isometric view of an embodiment of the tube of FIG. 39 shown from a different angle.

FIG. 41 is an isometric view of an embodiment of the tube of FIG. 39 shown from a different angle.

FIG. 42 is an isometric view of an embodiment of the tube of FIG. 39 shown from a different angle.

FIG. 43 is a perspective view of an embodiment of the tube of FIG. 39.

FIG. 44 is an isometric view of an embodiment of a rest.

FIG. 45 is an isometric view of an embodiment of the rest of FIG. 44 shown from a different angle.

FIG. 46 is an isometric view of an embodiment of the rest of FIG. 44 shown from a different angle.

FIG. 47 is an isometric view of an embodiment of the rest of FIG. 44 shown from a different angle.

FIG. 48 is an isometric view of an embodiment of the rest of FIG. 44 shown from a different angle.

FIG. 49 is a perspective view of an embodiment of the rest of FIG. 44.

FIG. 50 is an isometric view of an embodiment of a tube lid.

FIG. 51 is an isometric view of an embodiment of the tube lid of FIG. 50 shown from a different angle.

FIG. 52 is a perspective view of an embodiment of the tube lid of FIG. 50.

FIG. 53 is an isometric view of an embodiment of a piston attachment.

FIG. 54 is a sectional view on an embodiment of the piston attachment of FIG. 53.

FIG. 55 is an isometric view of an embodiment of the piston attachment of FIG. 53 shown from a different angle.

FIG. 56 is a perspective view of an embodiment of the piston attachment of FIG. 53.

FIG. 57 is an isometric view of an embodiment of a piston nut.

FIG. 58 is a sectional view on an embodiment of the piston nut of FIG. 57.

FIG. 59 is an isometric view of an embodiment of an outfall.

FIG. 60 is an isometric view of an embodiment of the outfall of FIG. 59 shown from a different angle.

FIG. 61 is an isometric view of an embodiment of the outfall of FIG. 59 shown from a different angle.

FIG. 62 is an isometric view of an embodiment of the outfall of FIG. 59 shown from a different angle.

FIG. 63 is a perspective view of an embodiment of the outfall of FIG. 59.

FIG. 64 is an isometric view of an embodiment of instant invention.

FIG. 65 is an isometric view of an embodiment of instant invention.

FIG. 66 is an isometric view of an embodiment of instant invention.

FIG. 67 is an isometric view of an embodiment of instant invention.

FIG. 68 is an isometric view of an embodiment of instant invention.

FIG. 69 is an isometric view of an embodiment of instant invention.

FIG. 70 is an isometric view of an embodiment of instant invention.

FIG. 71 is an isometric view of an embodiment of instant invention.

FIG. 72 is an isometric view of an embodiment of instant invention.

FIG. 73 is a perspective view of an embodiment of the instant invention.

FIG. 74 is a perspective view of an embodiment of the instant invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

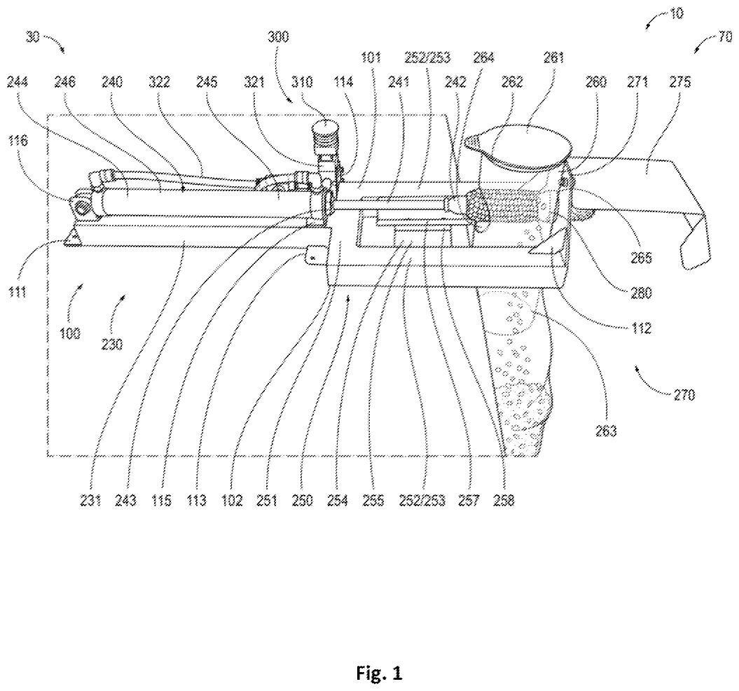

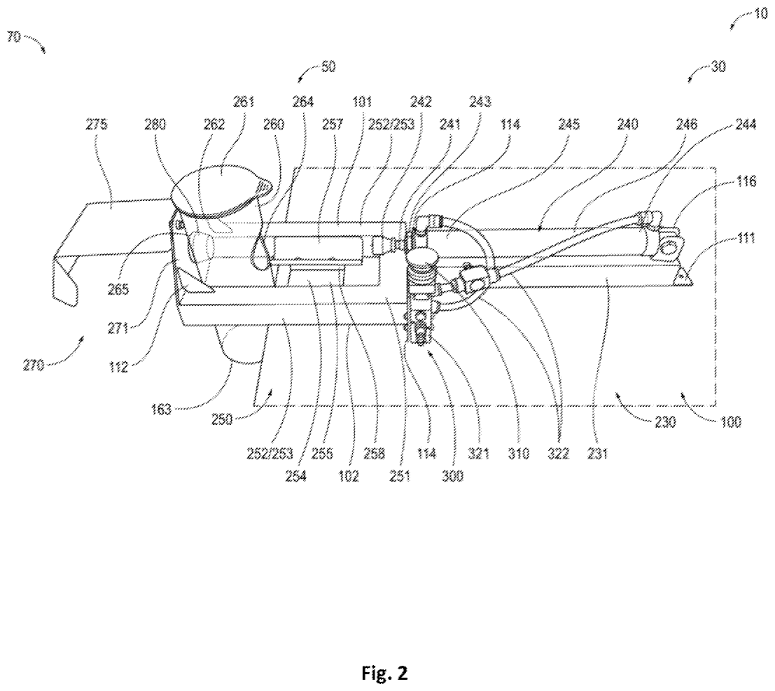

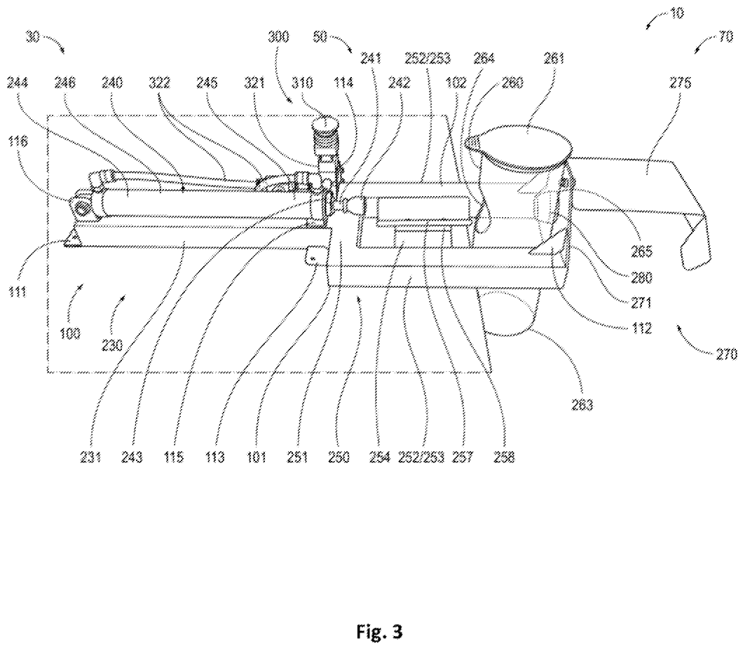

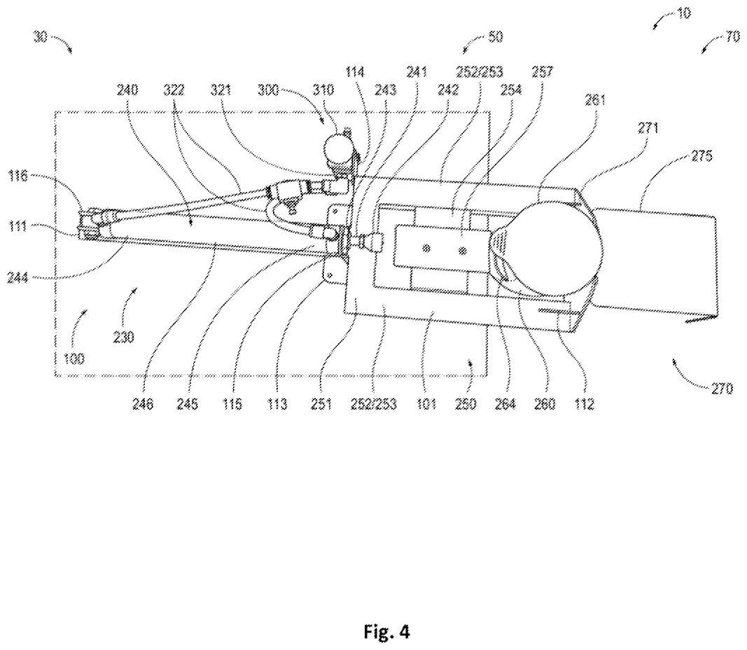

Referring to FIGS. 1 through 4 the present invention discloses a corn shucking device 10 and method for efficiently stripping corn kernels away from a corn cob. In a preferred embodiment of the present invention, the corn sucker 10 includes an ejection assembly 30, a harvesting assembly 50, and a discharge assembly 70.

In an exemplarily embodiment of the invention, the corn shucker includes a frame 100. In some embodiments, the frame 100 is comprised from a suitable material such as, for example, angle iron, steel, aluminum, square metal tubing, or the like. In a preferred embodiment of the present invention, the frame 100 includes a top face 101 and a bottom face 102. In some embodiments, the frame bottom face 102 is configured to be positioned on a mostly flat surface, such as a table. In other embodiments, the frame 100 is configured to be removably secured to a mostly flat surface.

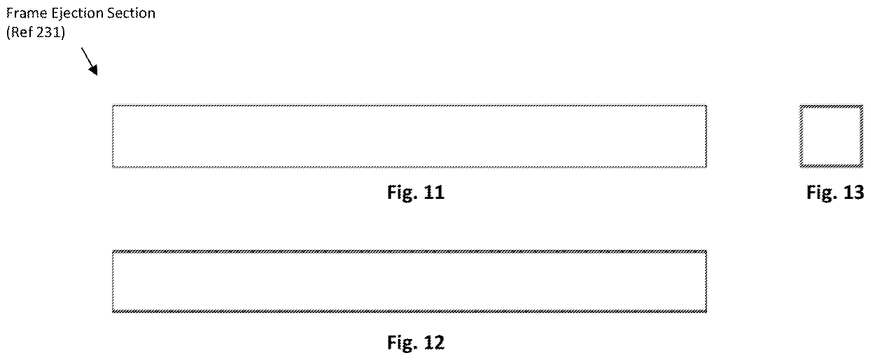

In some embodiments of the present invention, the frame 100 comprises an ejection section 230, a middle section 250, and a discharge section 270. Referring to FIGS. 1 through 4 and 11 through 13, in some embodiments, the ejection section 230 includes an elongated member 231. Still referring to FIGS. 11 through 13, in some embodiments, the elongated member 231 comprises an overall outer square shape and is made from metal, such as square metal tubing. In some embodiments, the elongated member 231 includes a first end 232 and a second end 233. In some embodiments of the present invention, the elongated member 231 is proximal to the frame middle portion 250 and the elongated member second end 233 extends distally away from the first end 232. In some embodiments, the first end 232 of the elongated member 231 is affixed to the frame middle section 250. In other embodiments, an end surface 234 of the elongated member 231 is affixed to the frame middle section 250 and extends in a direction away from the middle section 250 and is coplanar thereto. In some embodiments, an end surface 234 of the elongated member 231 is affixed to a first end portion 251 of the frame middle section 250 and extends in a direction away from the middle section 250 and is coplanar thereto. In some embodiments, the ejection section 230 is perpendicular to a portion of the middle section 250.

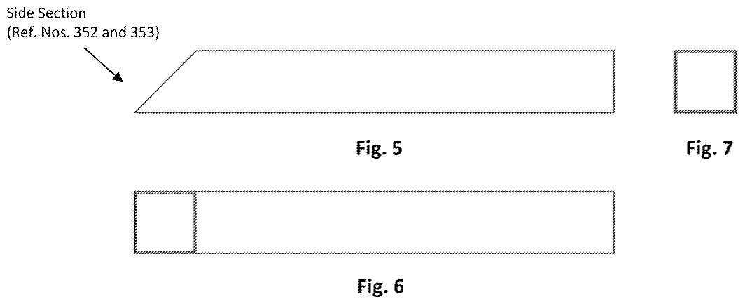

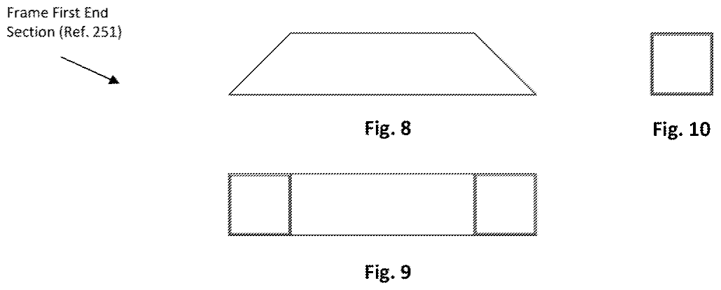

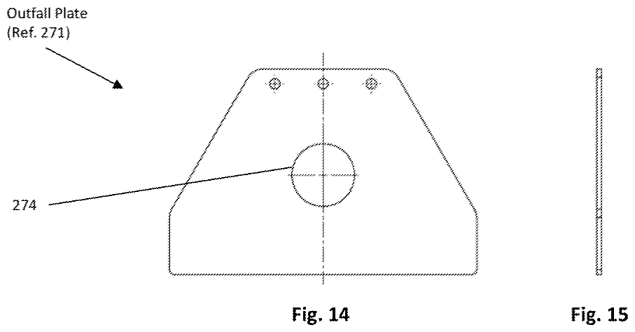

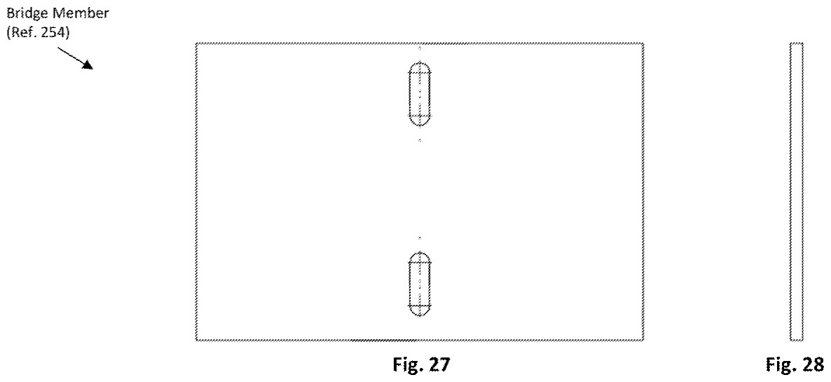

Referring to FIGS. 1 through 10, in a preferred embodiment of the instant invention, the frame 100 includes a middle section 250. In some embodiments, the frame middle section 250 comprises a first end portion 251. In other embodiments, the frame middle section 250 defines an overall “U” shape, having a void in the interior area between each respective side section. Referring to FIGS. 5 through 7, in some embodiments of the instant invention, the frame middle section 250 includes a first side 252 and a second side 253. In an exemplary embodiment, a first end of each respective first and second side portions is affixed to the middle section first end portion 251 and extends distally therefrom. Referencing FIGS. 1 through 4 and 14 though 15, in some embodiments, a second end of each respective first and second side portions is affixed to an outfall plate 271. Referencing FIGS. 27 through 28, in some embodiments, the frame middle section 250 comprises a bridge member 254, extending from the first side section 252 to the second side section 253. In one embodiment of the instant invention, the bridge member 254 defines an upper surface 255 and a bottom surface 256.

Still referring to FIGS. 1 through 4 and 14 through 15, in some embodiments, the corn shucker frame 100 includes an outfall plate 271. In some embodiments, the outfall plate 271 defines a first surface 272 and a second surface 273. In some embodiments of the present invention, the outfall plate 271 includes a plurality of apertures. In one embodiment of the instant invention, at least one outfall plate aperture is a mounting aperture. In other embodiments, at least one outfall plate aperture 274 is configured to receive a cutter 280. In some embodiments, the outfall plate 271 is configured to receive an outfall 275. In some embodiments, the outfall plate 271 is comprised of the same type of material, such as metal, as the frame 100; however, other materials are contemplated.

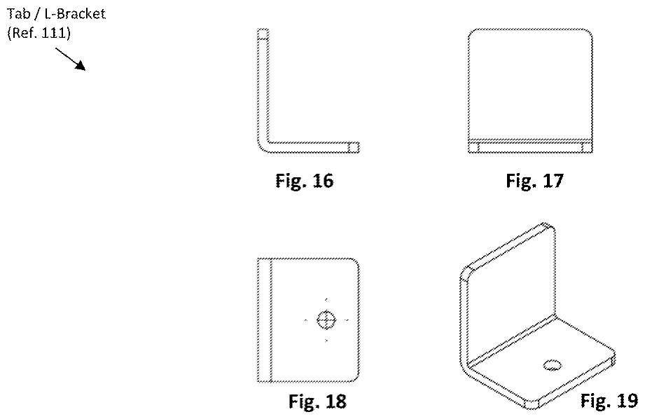

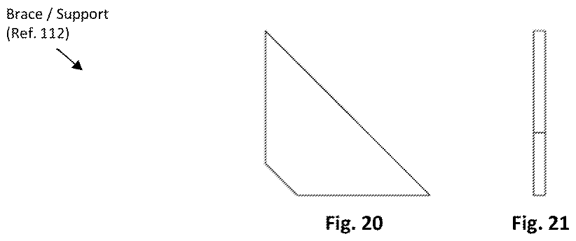

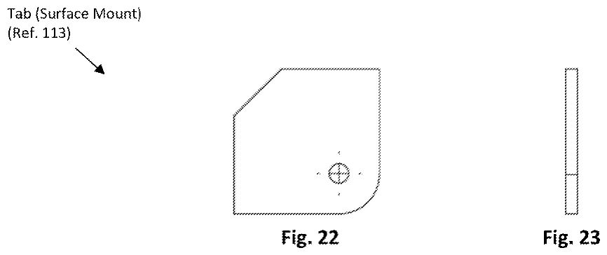

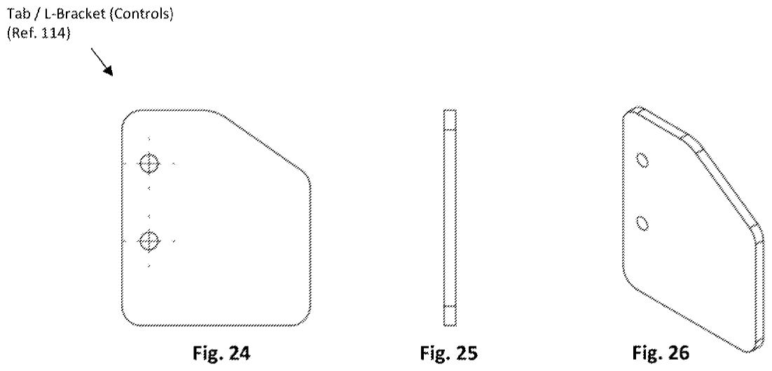

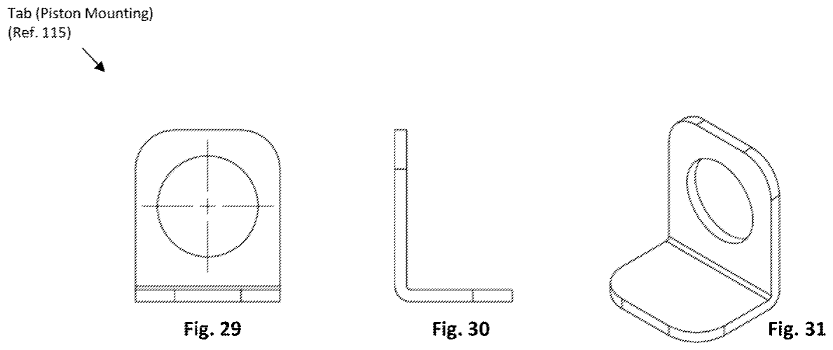

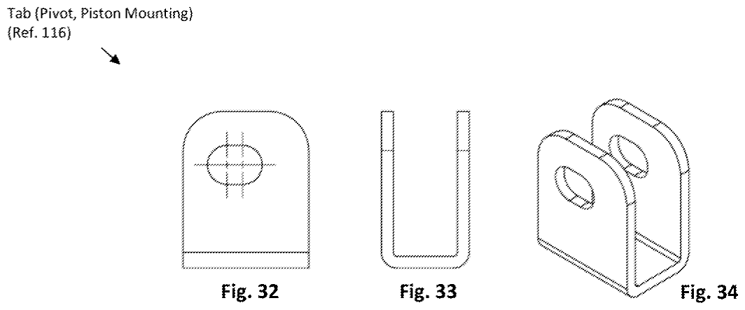

Referring to FIGS. 1 through 4, 16 through 26, and 29 through 34, in a preferred embodiment of the instant invention, the frame 100 comprises a plurality of tab or bracket members 110. In some embodiments, the tabs 114 are configured for affixing the invention's control components 300. In other embodiments of the present invention, the tabs 110 are designed in such a way as to receive a plurality of external components. In some embodiments, the tabs 110 are removably affixed to components via a fastener, such as a screw. In other embodiments, the tabs 112 are removably affixed to the outfall plate 271. In other embodiments, the tabs 113 removably affix the frame 100 to a surface. In some embodiments of the instant invention, the tabs 115 and 116 are configured to receive a pneumatic component, such as a piston.

Referring to FIGS. 1 through 4, in some embodiments of the present invention, the frame includes a plurality of braces 112. In some embodiments, a brace is affixed between the middle section side portions 252/253 and the outfall plate 271. In other embodiments, a brace is affixed between other surfaces of the frame 100. In some embodiment, the plurality of braces 112 are comprised from the same material as the frame 100.

Referring to FIGS. 1 through 4, in some embodiments of the instant invention, the corn shucker 10 includes a piston 240, such as a pneumatic piston or cylinder. As will be further discussed in relation to the figures, the piston is removably attached to the frame ejection section 230. In some embodiments, the piston 240 includes a piston rod 241 being housed within the piston 240 and being configured to extend outwardly therefrom. In some embodiments, an attachment 242 is removably affixed to an end portion of the piston rod 241. In some embodiments, the attachment 242 is affixed to the piston rod 241 via a threaded connection.

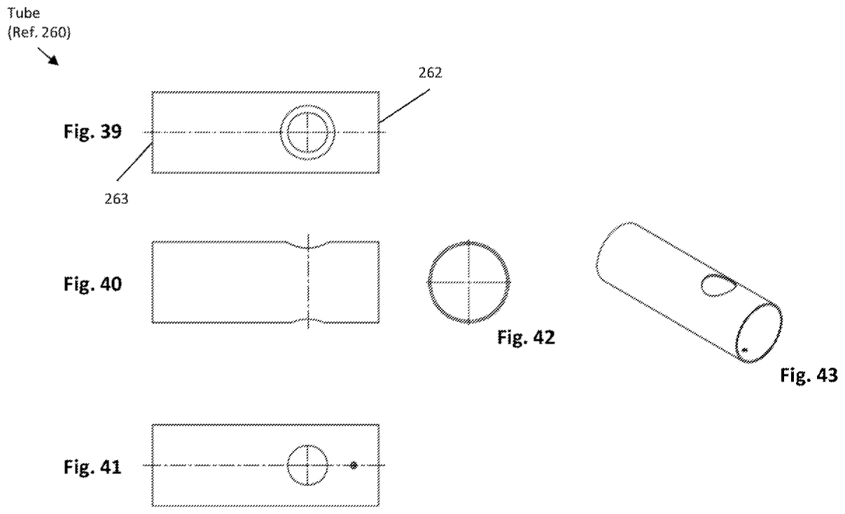

Referring to FIGS. 1 through 4, 39 through 43, and 50 through 52, in some embodiments of the instant invention, a tube 260 is positioned with a void area of the frame middle section 250. In another embodiment, the tube 260 is positioned withing a void area of the frame middle section 250 and removably affixed to the outfall plate 271. In some embodiments, the tube 260 is positioned perpendicular to the frame's top surface 101, such that a tube top opening 262 extends in an outward direction and away from the frame's top surface 101. In other embodiments of the instant invention, the tube 260 includes a lid 261, wherein the lid 261 is removably attached to the top opening 262. In some embodiments, the tube 260 includes a plurality of lids, the lids being removably affixed to a plurality of apertures. In some embodiments of the present invention, the tube 260 defines a bottom opening 263. In other embodiments, the tube 260 comprises a plurality of apertures. In some embodiments, the tube 260 includes an entry opening 264. In some embodiments of the present invention, the tube 260 includes a discharge opening 265. In some embodiments, the tube 260 includes apertures being configured for removably affixing the tube to the outfall plate 271. In some embodiments, the tube 260 is removably affixed to the outfall plate 271 by fasteners, such as screws.

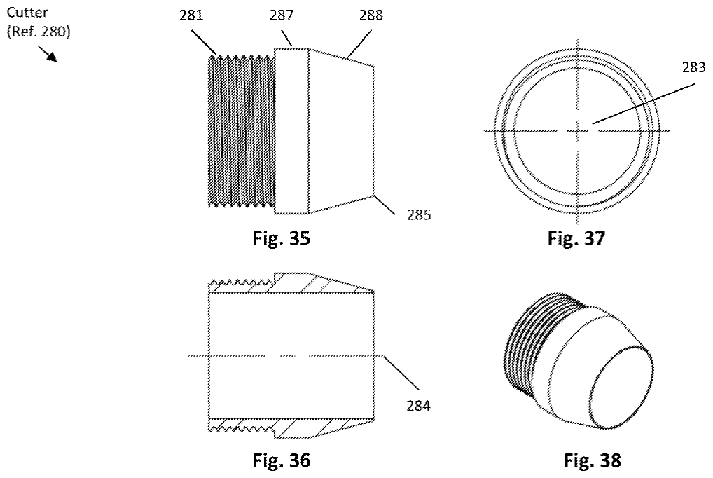

Referring to FIGS. 35 through 38, in an exemplarily embodiment of the invention, the corn shucker 10 includes a cutter 280. In a preferred embodiment, the cutter 280 defines a threaded section 281. In other embodiments, the cutter comprises a cutting section 282. In some embodiments, the threaded end 281 is distal to the cutting section 282. In one aspect of the invention, the cutter 280 includes an inner passage 283. Referencing FIGS. 35 through 38, the cutter 280 has a longitudinal axis 284 portraying the cutter 280 centered thereon. In some embodiments, the cutter 280 includes a cutting edge 285. In some embodiments, the cutter 280 is comprised from a metal material, such as stainless steel; however, other materials are contemplated.

Referring to FIGS. 35 through 38, in some embodiments, the cutter 280 comprises an overall circular shape. In other embodiments, the cutter 280 comprises other overall shapes. In a preferred embodiment, one end of the threaded section 281 is affixed to a cutter shoulder 286. In some embodiments, the cutter shoulder 286 has a flat surface section 287. In other embodiments, the one side of the cutter flat surface section 287 extends to a tapered section 288 and is tapered such that the tapered section 288 extends and ends at the cutting edge 285.

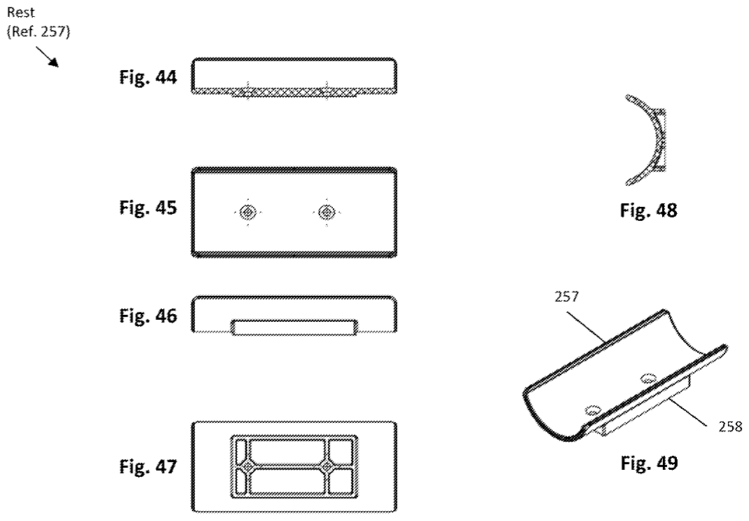

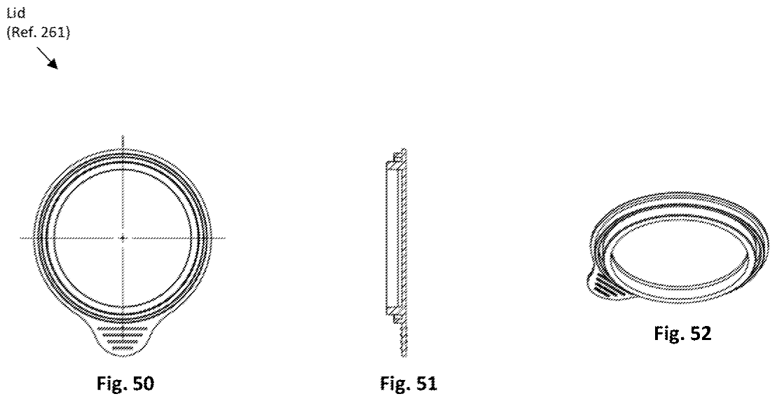

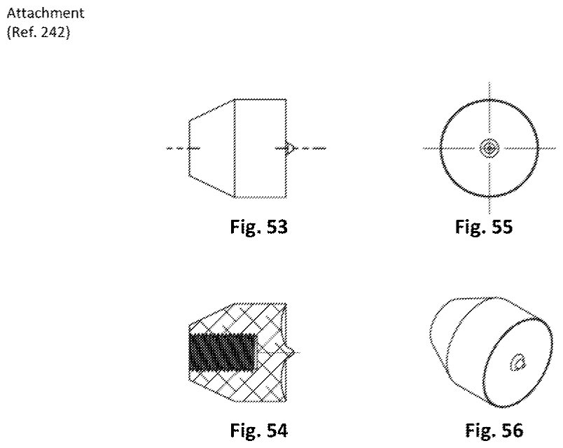

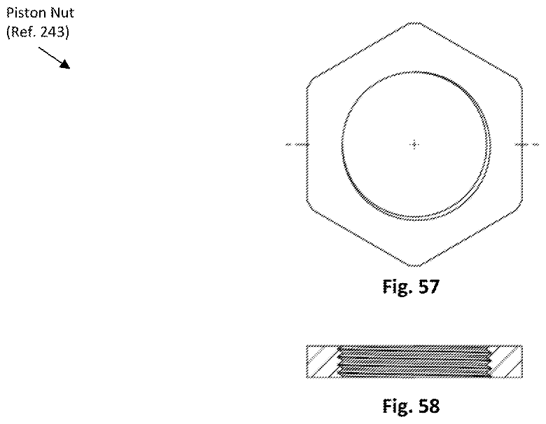

Referring to FIGS. 44 through 49, in some embodiments, the present invention includes a rest 257. In a preferred embodiment of the instant invention, the rest 257 is configured to securely support an elongated object, such as an ear of corn. In some embodiments, the rest 257 comprises a crescent design, such as a partial section of a pipe or tube. In other embodiments, the rest 257 comprises other designs, such as having a flat surface, or a “V” shape. In some embodiments, the rest 257 includes a base 258. In some embodiments, the base 258 is affixed to a bottom side of the rest 257. In some embodiments, the base 258 defines a rectangular shape. In some embodiments, the base 258 includes a plurality of support members. In some embodiments, the rest 257 includes a plurality of apertures. In other embodiments, the base 258 includes a plurality of apertures. In some embodiments, the plurality of apertures pass through the rest 257 and the base 258. In a preferred embodiment of the instant invention, the rest 257 is made from a plastic material; however other materials are contemplated. In some embodiments, the rest 257 is a holder, the holder being configured to support an elongated object, such as an ear of corn. In some embodiments, the rest 257 is configured to be removably affixed to a bridge member 254.

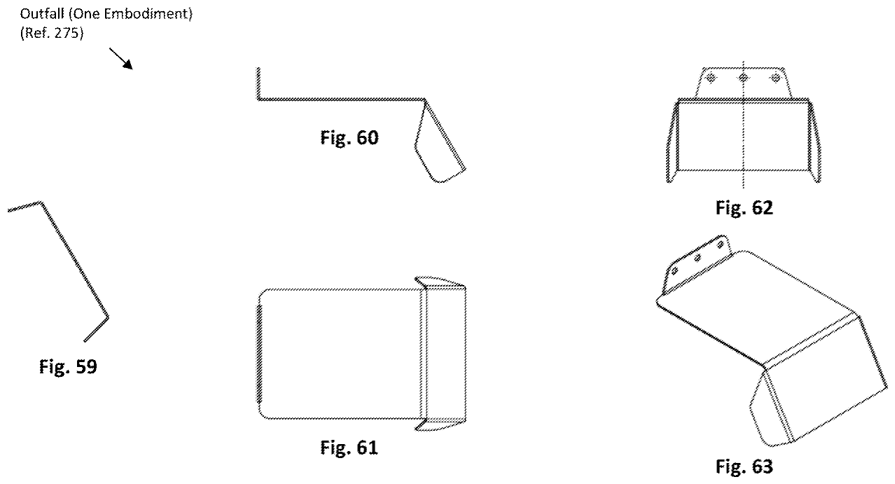

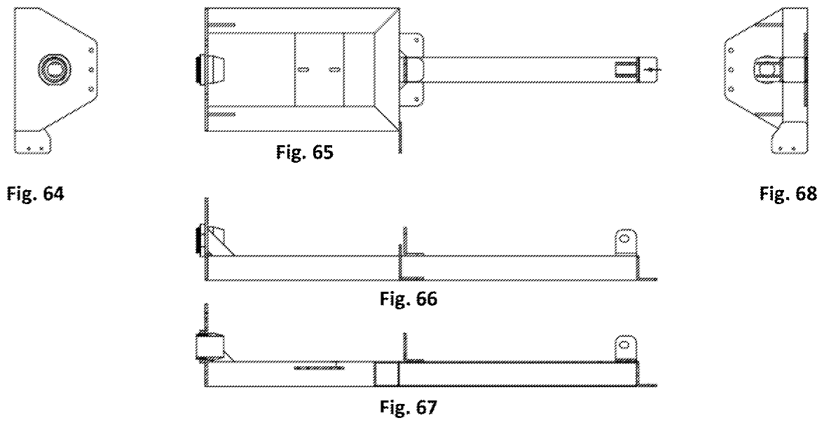

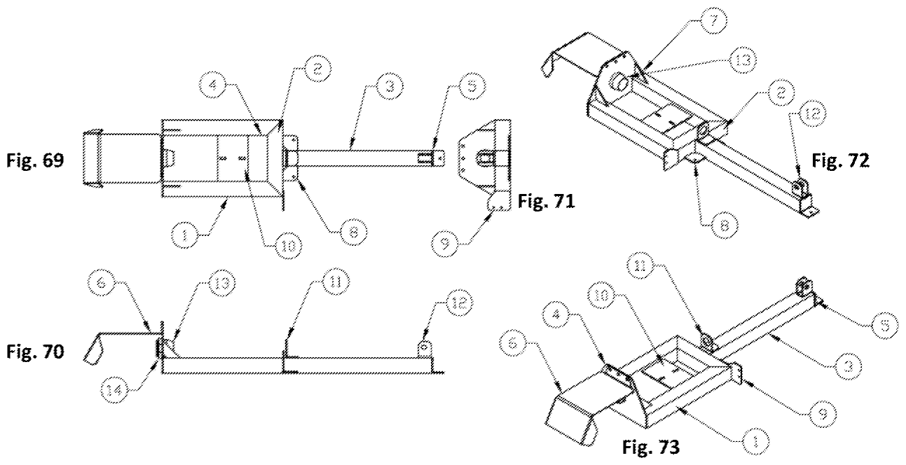

Referring to FIGS. 1 through 4 and 59 through 63, in preferred embodiment of the instant invention, the corn shucker 10 includes an outfall 257. In some embodiments, the outfall 257 is configured to guide an elongated object, such as a corn cob, in an outward direction away from the corn shucker 10. In some embodiments, the outfall 257 is comprised from a pipe assembly. In some embodiments, the pipe assembly includes a strait section of pipe, a coupling, and an elbow section. In some embodiments, the outfall 257 is a single pipe that guides an elongated object in a downward direction away from the corn shucker 10. In some embodiments, the pipe assembly is made from a polyvinyl chloride material; however, other materials are contemplated. In other embodiments, the outfall 257 is comprised of a deflector assembly. In some embodiments, the deflector assembly guides an elongated object in a downward direction away from the corn shucker 10. In some embodiments, the deflector assembly 257 is made from a material, such as metal; however, other materials are contemplated.

Referring to FIGS. 1 through 4, in an exemplary embodiment of the present invention, the corn shucker includes a control assembly 300. In some embodiments, the control assembly 300 comprises a button] 310, switch or the like. In some embodiments, the control assembly 300 includes a button 310 that operates a valve 321. In some embodiments, the button 310 operates a pneumatic valve 321, such as a pneumatic mechanical valve. In other embodiments, the button 310 is a momentary push button. In some embodiments, the control assembly 300 comprises a switch that operates electrical contacts. In other embodiments, the control assembly 310 includes a valve 321, such as a pneumatic mechanical valve.

In a preferred embodiment of the instant invention, the corn shucker 10 includes an ejecting assembly 30. In some embodiments, the ejecting assembly 30 is configured to move an elongated object, such as an ear of corn, from a first position to a second position. In some embodiments, the ejecting assembly 30 is movable from a first position to a second position. In some embodiments, the ejecting assembly 30 is movable from a cocked position to a fired position. In some embodiments, the ejecting assembly includes a pneumatic assembly, wherein the pneumatic assembly facilitates moving the piston 240 from a first position to a second position. In other embodiments, the ejecting assembly 30 is a manually operated assembly. In some embodiments, the ejecting assembly comprises a piston 240. In some embodiments, the ejecting assembly includes a plurality of hoses 322, such as air hoses, wherein the plurality of hoses 322 are configured to facilitate the movement of air though the ejection assembly 30.

In some embodiments, the piston 240 is moved from a first position to a second position. In some embodiments, the ejecting assembly's 30 first position corresponds to the piston's 240 first position. In some embodiments, the ejecting assembly's 30 second position corresponds to the piston's 240 second position.

Referring now to the drawings and in particular to FIGS. 1 through 4, in a preferred embodiment of the instant invention, a corn shucking device 10 is shown. In some embodiments, the corn shucker 10 includes an ejection assembly 30. In a preferred embodiment, the corn shucker 10 includes a frame 100. In some embodiments, the ejection assembly 30 comprises a frame ejection section 230. In some configurations, the frame ejection section 230 includes an elongated member 231. In some embodiments, an end section of the elongated member 231 is affixed to a frame middle section 250. In an exemplary embodiment of the present invention, the ejection assembly 230 includes a piston 240, such as a pneumatic piston. In some embodiments, the piston 240 is removably affixed to the elongated member 231 by one or more tab or bracket, such as an L-shaped bracket 115 or pivot bracket 116. Referring to FIGS. 1 through 4, in one embodiment, the piston's base 244 is removably affixed to the elongated member 231 by two opposing brackets 116, wherein the two brackets 116 are affixed to the frame's top face 101. In some embodiments, the piston 240 is removably affixed to the elongated member 231, such that the piston's body 246 is parallel to the frame's top face 101. In some embodiments, the piston's head section 245 is removably affixed to the elongated member 231 by a bracket 115. In other embodiments of the present invention, the piston's head section 245 is removably affixed to the elongated member 231 by a bracket 115 and a nut 243.

Refencing FIGS. 1 through 4, in a preferred embodiment, the piston 240 is removably affixed to the elongated member's top face 101, wherein the piston's base 244 is affixed to a distal portion of the elongated member 231 and the piston's head section 245 is affixed to the proximal section of the elongated member 231, and wherein the piston 240 is substantially parallel to the frame's top face 101.

In a preferred embodiment, a piston rod 241 extends away from the piston's head 245 and in a direction towards the frame's harvesting assembly 50. In some embodiments, the piston 240 is moved from a first position to a second position, thereby causing the piston rod 241 to move from a first position to a section position. In some embodiments, a portion of the piston rod 241 is retracted within the piston body 246 when the piston rod 241 is in the first position. In some embodiments, the piston rod 241 extends in an outward direction away from the piston's body 246 when the piston rod 241 is moved towards the second position. In some embodiments, the piston rod 241 moves in a direction substantially parallel to the ejection elongated member 231.

In a preferred embodiment of the present invention, moving the ejection assembly 30 from a first configuration to a second configuration causes the piston rod 241 to move from a first position to a second position. In some embodiments, a piston rod attachment 242 makes contact with a surface of an elongated object, such as a surface on an ear of corn, when the ejection assembly 30 moves from its first position to the second position. In some embodiments, a user utilizes controls 300 to move the ejection assembly 30 from its first position to the second position. In some embodiments, as the piston rod attachment 242 contacts the surface of the elongated object, such as a surface on an ear of corn, it forces the elongated object from its resting position in a direction towards the harvesting assembly 50. In some embodiments of the instant invention, as the elongated object passes through the harvesting assembly 50 it is then further urged towards the discharge assembly 70.

In some embodiments, moving the ejection assembly 30 from its first position to the second position causes an elongated object, such as an ear of corn, to be moved from its resting position in a direction towards a tube 260. In some embodiments, at least a portion of the elongated object, such as its kernels, remain in the harvesting assembly 50 and other portions, such as the core, or corn's cob, proceed in a direction towards and through the discharge assembly 70. In some embodiments, as the as the piston rod attachment 242 contacts a surface of an elongated object, such as a surface on an ear of corn, it forces the elongated object from its resting position in a direction towards a cutter 280.

In a preferred embodiment of the present invention, as the ejection assembly 30 is moved from a first configuration to its second configuration, an elongated object, such as an ear of corn, is urged in a direction, towards a cutter inner passage 283. In some embodiments, a cutter inner passage 283 has a diameter larger than the outer diameter of the elongated object core, such as a corn cob. In some embodiments the cutter's inner passage 283 has a diameter smaller than the overall outer diameter of the elongated object, such as an ear of corn. In an exemplary embodiment, as the ejection assembly 30 is moved from a first configuration to its second configuration, an elongated object, such as an ear of corn, is urged in a direction, towards a cutter inner passage 283, wherein the elongated object's core passes in a direction through the cutter inner passage 283, and the base of the corn's kernels contact a cutting edge 285. In some embodiments, as the corn's kernels contact a cutting edge 285, the kernels are separated from the elongated object's core, such as a corn cob.

In an exemplary embodiment of the instant invention, as the ejection assembly 30 is moved from a first configuration to its second configuration, an elongated object, such as an ear of corn, is urged in a direction, towards a tube 260 then proceeds in a direction towards a cutter 280, where part of the elongated object, such as its kernels remain in the harvesting section, and wherein a second part of the elongated object, such as its core passes through a cutter inner passage 283 and continues in a direction towards the discharge assembly 70.

In some embodiments, the ejection assembly 30 is moved from its first position to a second position by means of air pressure, such as in a pneumatic assembly. In other embodiments, electrical power moves the ejection assembly 30 from its first position to the second position. In other embodiments, the ejection assembly 30 is moved from its first position to a second position by a user applying physical force to a lever, press, or the like. In some embodiments, the ejection assembly 30 is moved from its first position to a second position and then returned to the first position after urging an elongated object, such as an ear of corn, in a direction towards a cutter inner passage 283.

In some embodiments, with the ejection assembly 30 is a first configuration, the first configuration corresponding with a portion of the piston rod 241 being mostly retained in piston body 246 and in a rearward position towards the ejection elongated member's 231 distal area, a user places an elongated object, such as an ear of corn, on a rest 257. In some embodiments, before placing the ear of corn on the rest 257, its leaves, husk, and silk layers are removed. After placing an elongated object, such as an ear of corn, on a rest 257, the user moves the controls 300 from a first configuration to a second configuration. Moving the controls 300 to their second configuration, thereby causes the ejection assembly 30 to move from its first configuration to a second configuration. Moving the ejection assembly 30 from its first position to its second configuration causes the piston rod 241 to move from its first position to a second piston. As the piston rod 241 moves from its first position to the second position, a piston rod attachment 242 contacts an end area of the elongated object, such as an ear of corn, on a rest 257. As the ejection assembly 30 moves from its first configuration to the second configuration the elongated object is urged towards a tube 260 and in a direction towards a cutter 280. As the elongated object continues in a direction towards the discharge assembly 70, and as the elongated object passes through a cutter inner passage 283, part of the elongated object, such as its kernels, are separated from its core, such as the corn cob, by a cutter edge surface 285. After being separated, the kernels remain in the harvesting area 50 and gravity forces the kernels in a downward direction towards a bottom opening 263 in the tube 260. A container, such as a bag is secured to the tube bottom opening 263, such that the kernels are collected in the container after being separated from the elongated object's core. After being separated from the kernels, the elongated object's core continues in a direction towards the discharge assembly 70. The piston rod 241 may return from the second configuration to the first configuration to repeat the process described herein. In some embodiments, the return of the piston rod 241 from the second configuration to the first configuration is done automatically through the means powering the present invention. In some embodiments, the return of the piston rod 241 to from the second configuration to the first configuration is done manually (for example, the user pressing a button or other control mechanism on the controls 300).

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new, and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A corn stripping device comprising:
an ejection assembly;
a harvesting assembly; and
a control system.

2. The corn stripping device as claimed in claim 1, wherein the ejection assembly comprises a frame ejection section, wherein a first end of the frame ejection section extends from a first end of the corn stripping device, and wherein the second end is affixed to a surface of a frame middle section.

3. The corn stripping device as claimed in claim 2, wherein the ejection assembly further comprises a piston, wherein a piston base is pivotally mounted to a top surface of the first end of the frame ejection section, and wherein a piston head is removably affixed to a piston bracket.

4. The corn stripping device as claimed in claim 3, wherein the piston bracket is affixed to a top portion the second end of the frame ejection section.

5. The corn stripping device as claimed in claim 4, wherein the piston comprises a piston rod.

6. The corn stripping device as claimed in claim 5, wherein a piston rod attachment is removably affixed an end portion of the piston rod.

7. The corn stripping device as claimed in claim 1, wherein the harvesting assembly comprises a frame middle section.

8. The corn stripping device as claimed in claim 7, wherein the frame middle section comprises:
a center member, wherein a first end surface of the center member is affixed to a second end of a second end of the frame ejection section;
a first side member, the frame first side member being affixed to a first end of the center member, and wherein the first side member extends from the center member towards a discharge plate; and
a second side member, the frame member side section being affixed to a second end of the center member, and wherein the second side member extends from the center member towards the discharge plate.

9. The corn stripping device as claimed in claim 1, further comprising a cutter, the cutter being removably affixed to a discharge plate.

10. The corn stripping device as claimed in claim 9, wherein a cutter first portion extends from a surface of the discharge plate in a direction towards the harvesting assembly.

11. The corn stripping device as claimed in claim 10, wherein a cutter second portion extends from a second surface of the discharge plate towards the discharge assembly.

12. The corn stripping device as claimed in claim 11, wherein the cutter first portion includes an edge section, the edge section being configured to separate a first portion of an elongated item from its inner core.

13. The corn stripping device as claimed in claim 12, wherein the elongated item is an ear of corn.

14. The corn stripping device as claimed in claim 13, wherein a piston rod attachment is configured to contact an end portion of the elongated object, wherein the ejection assembly urges the elongated object in a direction towards the cutter, wherein the elongated object path of travel is substantially parallel to a frame top surface.

15. The corn stripping device as claimed in claim 14, wherein the inner core passes through a cutter inner opening.

16. The corn stripping device as claimed in claim 1, further comprising a discharge assembly.

17. A method of stripping corn from a corn cob, the method comprising:
placing an elongated object on a rest;
actuating a button from its first position to a second position, thereby causing an ejection assembly to move from a first configuration to a second configuration; and
moving the elongated object in a direction towards a cutter, wherein the cutter is removably affixed to a discharge plate, wherein a cutter first portion extends from a surface of the discharge plate in a direction towards a harvesting assembly, and wherein the cutter first portion includes an edge section, the edge section being configured to separate a first portion of an elongated item from its inner core;
accumulating the first portion of the elongated item within a harvesting assembly; and
returning the ejection assembly from the second configuration to the first configuration.

18. The method of stripping corn from a corn cob as claimed in claim 17, wherein the elongated item is an ear of corn.

19. The method of stripping corn from a corn cob as claimed in claim 17, wherein the ejection assembly comprises a piston, wherein a piston base is pivotally mounted to a top surface of the first end of the frame ejection section, and wherein a piston head is removably affixed to a piston bracket.

20. The method of stripping corn from a corn cob as claimed in claim 19, wherein a piston rod attachment is configured to contact an end portion of the elongated object, wherein the ejection assembly urges the elongated object in a direction towards the cutter, and wherein the elongated object path of travel is substantially parallel to a frame top surface.
